(19) United States
(12) Patent Application Publication
(10) Pub. No.: US 2009/0303007 A1
(43) Pub. Date: Dec. 10, 2009

(54) MULTIPLE BAND RFID READER DEVICE

(76) Inventors: Byung Hoon Ryou, Seoul (KR); Won Mo Sung, Gyeonggi-do (KR); Chang Hyun Park, Incheon (KR); Dong Ryul Shin, Daegu (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/308,807

(22) PCT Filed: Jul. 6, 2007
(86) PCT No.: PCT/KR2007/003282

§ 371 Date: Apr. 9, 2009

(30) Foreign Application Priority Data
Jul. 10, 2006 (KR) 10-2006-0064173

(51) Int. Cl. H04Q 5/22

(52) U.S. Cl. 340/10.1

(57) ABSTRACT

There is disclosed a multi-band RFID reader, including a duplexer for separating a data signal received from a tag according to a frequency band, a directional coupler for diverging a part of the signal separated through the duplexer, a Digital Signal Processor (DSP) for determining a frequency band of the diverged signal and generating a control signal based on the determination result, and Radio Frequency (RF) switch for turning on/off transmission/reception modes in response to the control signal of the DSP. The multi-band RFID reader can read signals received from various kinds of tags by employing a multi-frequency band irrespective of frequency bands.

### TECHNICAL FIELD

The present invention relates to a multi-band Radio Frequency IDentification (RFID) reader, and more particularly, to a multi-band RFID reader in which communication between a tag and a RFID reader can be performed despite a difference in the frequency between UHF (860 MHz-960 MHz) bands and a 2.45 GHz band.

### BACKGROUND ART

The prior art belonging to the technical field of the present invention will be described below with reference to the drawing.

FIG. 1 illustrates a conventional RFID reader system.

As shown in FIG. 1, the conventional RFID reader system includes a tag 10 that can perform communication by employing a specific frequency band, a RFID reader 20 that transmits/receives a RF signal to/from the tag 10, and a host computer 30, which determines a signal received from the RFID reader 20 and performs a specific process.

The tag 10 can have a small integrated circuit chip built therein. The integrated circuit chip can be input with various pieces of information and hence can be applied to a variety of application fields, such as logistic management identification, electronic identity documents, electronic money, credit cards, and animal recognition. Meanwhile, the RFID reader 20 includes an antenna 22 configured to wirelessly transmit/receive a data signal to/from the tag, and a circuit unit 24 connected to the antenna 22 and configured to transmit/receive the data signal to/from the host computer 30. The RFID reader 20 intermediates smooth data transmission between the tag 10 and the host computer 30.

In general, the tag 10 for use in the RFID reader system can be largely classified into tags of the UHF bands and the 2.45 GHz band depending on a use frequency. The conventional RFID reader 20 has been fabricated to operate in only one of the two bands, and thus is problematic in that at least two RFID readers 20 covering different bands must be included in order to read data smoothly irrespective of the type of a tag.

Further, in case where the single antenna 22 is used for both of transmission and reception in each RFID reader 20 covering each of the bands, a technical problem also arises because isolation of −40 dB or less, i.e., a minimal transmission/reception isolation for recognizing the tag 10 must be satisfied.

### DISCLOSURE OF INVENTION

### Technical Problem

Accordingly, the present invention has been made in view of the above problems occurring in the prior art, and an object of the present invention is to provide a multi-band RFID reader, which can read a signal received from various kinds of tags employing a multi-frequency band, irrespective of frequency bands.

### Technical Solution

To achieve the above object, according to a preferred embodiment of the present invention, there is provided a multi-band RFID reader, including a duplexer for separating a data signal received from a tag according to a frequency band, a directional coupler for diverging a part of the signal separated through the duplexer, a Digital Signal Processor (DSP) for determining a frequency band of the diverged signal and generating a control signal based on the determination result, and Radio Frequency (RF) switch for turning on/off transmission/reception modes in response to the control signal of the DSP.

It is preferred that the RF switch periodically switches the transmission mode and the reception mode when the control signal is received. The RFID reader may transmit or receive different frequency band signals with a time delay so that data transmission/reception of high reliability is guaranteed. Further, preferably, in the RFID reader, transmission and reception paths of the signal are separated according to operations of the RF switch, thereby improving a recognition rate of the tag.

The duplexer may separate the data signal into a UHF band signal and a 2.45 GHz band signal.

To achieve the above object, according to another embodiment of the present invention, there is provided a multi-band RFID reader, including a duplexer for separating a data signal of a tag, received through an antenna, according to frequency bands, a DSP for generating a control signal based on the separated signal, and RF switch for turning on/off transmission/reception modes in response to the control signal of the DSP.

It is preferred that the RF switch periodically switches the transmission mode and the reception mode when the control signal is received. The RFID reader may transmit or receive different frequency band signals with a time delay so that data transmission/reception of high reliability is guaranteed. Further, preferably, in the RFID reader, transmission and reception paths of the signal are separated according to operations of the RF switch, thereby improving a recognition rate of the tag.

Meanwhile, the duplexer may separate the data signal into a UHF band signal and a 2.45 GHz band signal. Further, the DSP can determine whether the antenna has received the data signal to generate the control signal.

### Advantageous Effects

Through the construction above, the present invention provides a multi-band RFID reader, which can read signals received from tags by employing a multi-frequency band, irrespective of frequency bands.

### BRIEF DESCRIPTION OF THE DRAWINGS

FIG. 1 illustrates a conventional RFID reader system;

FIG. 2 illustrates a RFID reader system according to an embodiment of the present invention;

FIG. 3 is a transmission timing diagram employing a multi-band operation of the RFID reader according to an embodiment of the present invention; and

FIG. 4 illustrates an internal configuration of the RFID reader according to an embodiment of the present invention.

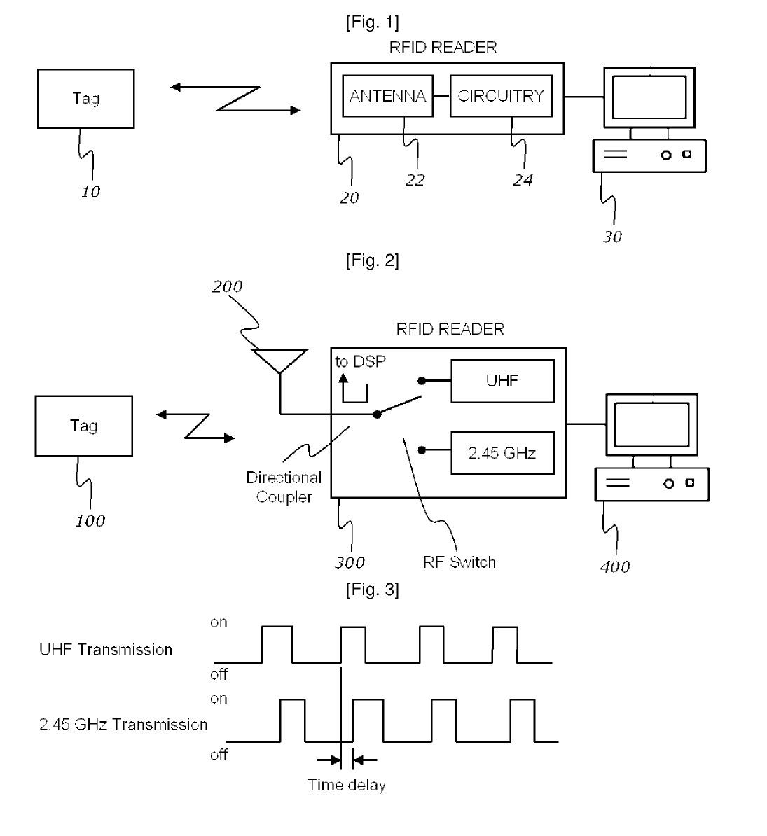

### MODE FOR THE INVENTION

The present invention will now be described in detail in connection with specific embodiments with reference to the accompanying drawings. The embodiments are only examples, and the present invention is not limited to the embodiments.

FIG. 2 illustrates a RFID reader system according to an embodiment of the present invention. As shown in FIG. 2, the RFID reader system of the present embodiment includes various kinds of tags 100 that communicate one or more frequency band signals, an antenna 200 configured to transmit/receive a wireless signal to/from the tag 100 and having a detachable type, a RFID reader 300 connected to the antenna 200 and configured to input/output signals, and a host computer 400 that determines signals received from the RFID reader 300 and performs a specific process.

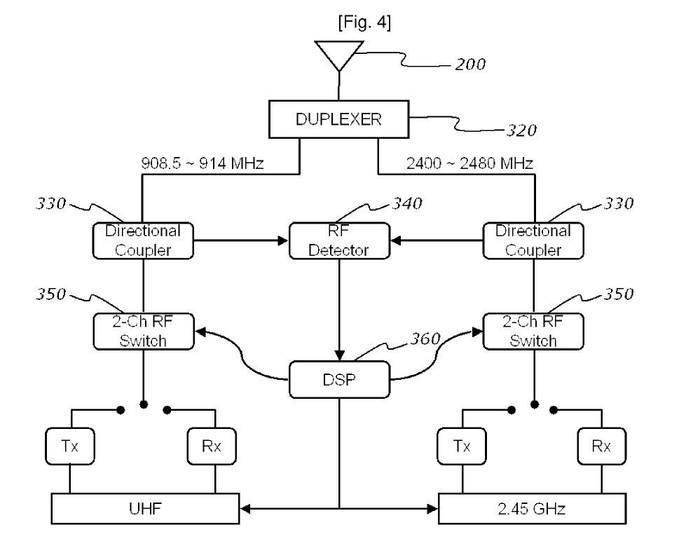

The RFID reader 300 includes a duplexer (320 of FIG. 4) that separates a data signal received from the tag 100, according to a frequency band, a Radio Frequency (RF) detector (340 of FIG. 4) that determines whether a signal separated through the duplexer 320 exists, RF switches (350 of FIG. 4) that switches transmission/reception paths of a data signal, and a DSP (360 of FIG. 4) that controls the operation of the RF switches 350. The DSP 360 can be replaced with any constituent element being capable of controlling the RF switch. As a representative example, the DSP 360 can be replaced with a Field-Programmable Gate Array (FPGA). That is, in construing the claims of the invention of the present application, a substantial function of each constituent element should be considered rather than being limited to the name of each constituent element. Each of the constituent elements is described later.

FIG. 3 is a transmission timing diagram employing a multi-band operation of the RFID reader according to an embodiment of the present invention.

Referring to FIG. 3, data transmission/reception in the RFID reader 300 of the present embodiment are performed as a transmission mode and a reception mode are turned on/off periodically in each frequency band. In more detail, the RF switches 350 alternately establish the transmission path and the reception path periodically under the control of the DSP, so that data transmission/reception with high reliability can be guaranteed.

The RFID reader 300 of the present embodiment performs data transmission by employing different bands. Thus, there is no problem in data transmission/reception employing single antenna 200, but preferably a predetermined time delay is given in transmitting the UHF bands and the 2.45 GHz band for data transmission/reception with high reliability, preventing interference at the time of data transmission. This is true of signal reception.

FIG. 4 illustrates an internal configuration of the RFID reader according to an embodiment of the present invention.

As shown in FIG. 4, the RFID reader 300 includes the duplexer 320 that separates a data reception signal, received from the tag 100, according to a frequency band, directional couplers 330 that diverge a part of the reception signal separated through the duplexer 320 and transfer the diverged signal to the RF detector 340, the RF detector 340 that determines whether a signal received from the directional couplers 330 exists and transfers a detected signal, the DSP 360 that determines a frequency band of the signal received from the RF detector 340 and controls the RF switches 350 formed on a corresponding frequency band signal path, and the RF switches 350 that turn on/off the transmission/reception modes in response to a control signal of the DSP 360.

An operational process of the RFID reader 300 is described below. If a reception signal is detected through the multi-band antenna 200, the duplexer 320 separates the reception signal into signals of a UHF band and a 2.45 GHz band. The separated signals are transmitted to the RF detector 340 through the directional couplers 330 formed on the reception paths of the respective bands.

In more detail, a coupled output of the directional couplers 330 is connected to the RF detector 340, and a part of the received signal is transmitted to the RF detector 340. The RF detector 340 detects the existence of the signal and transmits the signal to the DSP 350. Thereafter, the RF detector 340 transmits the detected signal to the DSP 360. The DSP 360 determines a frequency band of the received signal, and transmits a control signal to the RF switch 350 formed on the reception path of a corresponding band based on the determination result. Before the control signal is received, the RF switch 350 is in the transmission mode, and periodically shifts between the transmission mode and the reception mode according to GEN2 or EPC Class1, Class2, ISO/IEC 18000-4, 18000-6B, 6C rules when the control signal is received from the DSP 360.

If no received signal is input from the DSP 360, the RF switches 350 of the respective bands are in the transmission mode. If the received signal is input to both the UHF band and the 2.45 GHz band, both of the RF switches 350 are repeatedly turned on/off.

Through this construction, the operation of the RF switches 350 can be minimized and power consumption can be minimized.

In accordance with another embodiment of the present invention, the RF switches 350 can be controlled by only the DSP 360 without the directional couplers 330 or the RF detector 340. In this case, the RF switches 350 are repeatedly turned on/off without regard to the input of a received signal in order to wait for data reception. By doing so, a reader having a more simplified circuit configuration can be implemented.

Alternatively, the two RF switches 350 can be maintained to an on state, and then repeat on and off states according to the control signal of the DSP 360. In more detail, the DSP 360 can be connected to the antenna, and can determine whether a received signal is input, and operate all the RF switches 350 formed on the signal transfer paths of the UHF band and the 2.45 GHz band when the received signal is received, simplifying a construction. In this case, there is a disadvantage in that power consumption of the whole system is great compared with the above embodiment, but the system configuration can be simplified and the fabrication cost of a RFID reader can be saved.

The conventional RFID reader was disadvantageous in that the recognition rate of the tag 100 was low because transmission/reception isolation was not complete. However, the present invention can solve the problem by fully separating paths along which signals are transmitted at the time of transmission/reception through the RF switches 350.

Further, according to the multi-band RFID reader 300 constructed above, various kinds of tags 100 employing a multi-band can be recognized through a single RFID reader 300 irrespective of the type of the tag 100. Accordingly, high price competitiveness can be accomplished and space utilization can be improved compared with the prior art in which an additional reader for recognizing various kinds of the tags 100 must be included.

Although the specific embodiments of the present invention have been disclosed for illustrative purposes, those skilled in the art will appreciate that various modifications, additions and substitutions are possible, without departing from the scope and spirit of the invention as disclosed in the accompanying claims. Therefore, the scope of the present invention should be determined based on accompanying claims.

1. A multi-band Radio Frequency IDentification (RFID) reader, comprising:
a duplexer for separating a data signal received from a tag according to a frequency band;
a directional coupler for diverging a part of the signal separated through the duplexer;
a Digital Signal Processor (DSP) for determining a frequency band of the diverged signal and generating a control signal based on the determination result; and
Radio Frequency (RF) switch for turning on/off transmission/reception modes in response to the control signal of the DSP.

2. The multi-band RFID reader of claim 1, wherein the RF switch periodically switches the transmission mode and the reception mode when the control signal is received.

3. The multi-band RFID reader of claim 1, wherein different frequency band signals are transmitted or received with a time delay so that data transmission/reception of high reliability is guaranteed.

4. The multi-band RFID reader of claim 1, wherein transmission and reception paths of the signal are separated according to operations of the RF switch, thereby improving a recognition rate of the tag.

5. The multi-band RFID reader of claim 1, wherein the duplexer separates the data signal into a UHF band signal and a 2.45 GHz band signal.

6. A multi-band RFID reader, comprising:
a duplexer for separating a data signal of a tag, received through an antenna, according to frequency bands;
a DSP for generating a control signal based on the separated signal; and
RF switch for turning on/off transmission/reception modes in response to the control signal of the DSP.

7. The multi-band RFID reader of claim 6, wherein the RF switch periodically switches the transmission mode and the reception mode when the control signal is received.

8. The multi-band RFID reader of claim 6, wherein different frequency band signals are transmitted or received with a time delay so that data transmission/reception of high reliability is guaranteed.

9. The multi-band RFID reader of claim 6, wherein transmission and reception paths of the signal are separated according to operations of the RF switch, thereby improving a recognition rate of the tag.

10. The multi-band RFID reader of claim 6, wherein the duplexer separates the data signal into a UHF band signal and a 2.45 GHz band signal.

11. The multi-band RFID reader of claim 6, wherein the DSP determines whether the antenna has received the data signal to generates the control signal.
